(19) United States
(12) Patent Application Publication
(10) Pub. No.: US 2017/0197739 A1
(43) Pub. Date: Jul. 13, 2017

(54) POWDERED MEDICINE DISPENSING APPARATUS, AND POWDERED MEDICINE DISPENSATION PACKAGING APPARATUS USING SAME

(71) Applicant: Soo Sun HA, Seoul (KR)

(72) Inventor: Soo Sun HA, Seoul (KR)

(21) Appl. No.: 15/321,288

(22) PCT Filed: Jun. 24, 2015
(86) PCT No.: PCT/KR2015/006441

§ 371 Date: Dec. 22, 2016

(30) Foreign Application Priority Data
Jun. 24, 2014 (KR) 10-2014-0077048
Jan. 30, 2015 (KR) 10-2015-0014706

(51) Int. Cl. B65B 1/04; B65B 39/00; B65B 5/10; A61J 1/00

(52) U.S. Cl. CPC B65B 1/04; A61J 1/00; B65B 39/007; B65B 5/101

(57) ABSTRACT

The present invention relates to a powdered medicine dispensing apparatus, and a powdered medicine dispensation packaging apparatus using the same. According to the present invention, the production cost of the apparatus is significantly reduced, and thereby more precise uniform dispensing of the powered medicine can be facilitated while relying on half-manual operation by a worker, many distribution operations can be performed easily and speedily, and dispensing can be made responsive according to the amount that is dispensed and the amount that is packaged.

### TECHNICAL FIELD

The present invention relates to a powdered medicine dispensing apparatus and a powdered medicine dispensation packaging apparatus using the same. More particularly, it relates to a powdered medicine dispensing apparatus and a powdered medicine dispensation packaging apparatus using the same that may significantly reduce the production cost of equipment to enable a more precise uniform dispensing of the powdered medicine while relying on half-manual work by a worker, allow many distribution operations to be performed easily and speedily, and dispense responsively according to an amount that is dispensed and an amount that is packaged, and a powdered medicine dispensation packaging apparatus using the same.

### BACKGROUND OF ART

In general, medicines are classified into tablet form, capsule form, powdered medicine, liquid medicine and the like.

These medicines are prescribed by a physician to be taken routinely 1 to 3 times a day depending on the needs of each patient.

However, of the medicines mentioned above, most tablets, capsules, and liquid medicine may be dispensed easily according to one uniform dose, but due to the characteristic of powdered medicine, a precise machine must be used or a worker must use a specific sized spoon and the like for every single one.

However, powdered medicine dispensing apparatuses of the prior arts are not precise, and require much time for many distribution operations or the costs are very high, and have a disadvantage that a different machine must be used according to formulation (Patent document 1: Korean granted patent No. 10-0699689, Patent document 2: Korean patent application publication No. 10-2008-0017333).

Furthermore, in a case of dispensation by hand, the work must be done in a constantly tense state along with skills by hand, causing not only severe stress for workers, but also there is a problem of the dispensation not being done precisely.

### DISCLOSURE OF THE INVENTION

### Technical Problem

The present invention has been designed to improve the aforesaid characteristics of the prior arts, and its object is to provide a powdered medicine dispensing apparatus and a powdered medicine dispensation packaging apparatus using the same that may significantly reduce the production cost of equipment to enable a more precise uniform dispensing of the powdered medicine while relying on half-manual work by a worker, allow many distribution operations to be performed easily and speedily, and dispense responsively according to an amount that is dispensed and an amount that is packaged, and a powdered medicine dispensation packaging apparatus using the same.

### Technical Solution

In order to accomplish the above present object, the present invention is configured as follows.

A powdered medicine dispensation packaging apparatus according to the present invention comprises, a partition means having a frame with a space of predetermined size, that divides the frame horizontally and vertically to form unit cells for powdered medicine to be uniformly distributed; a driving means connected to a vertically partitioning member whereby a vertical spacing of a member is adjusted; a dispensing means arranged under the partition means dispensing divided powdered medicine to split inject into a medicine wrapping paper; and a holding unit supporting the medicine wrapping paper.

On the other hand, a powdered medicine dispensation packaging apparatus according to the present invention is configured to comprise a partition means having a frame with a space of predetermined size, that divides the frame horizontally and vertically to form unit cells for powdered medicine to be uniformly distributed; a driving means connected to a vertically partitioning member whereby a vertical spacing of a member is adjusted; a dispensing means arranged under the partition means that dispenses divided powdered medicine; a plurality of individual slots whereby the divided powdered medicine dispensed from a powdered medicine dispensing apparatus is moved individually; an upper guide plate supporting the individual slots horizontally; a first horizontal driving unit that moves the individual slots horizontally as it moves horizontally along the upper guide plate; a first vertical driving unit provided at one side of the first horizontal driving unit, that moves the individual slots vertically; a second horizontal driving unit located at a lower part of the first horizontal driving unit, that moves the individual slots which were transferred by the first vertical driving unit, horizontally; an auxiliary slot unit provided under the second horizontal driving unit, which simultaneously opens an upper part of a medicine wrapping paper moving horizontally and injects powdered medicine stored in the individual slots into medicine wrapping paper; a lower guide plate arranged between the second horizontal driving unit and auxiliary slot unit to guide movement of individual slots; and a second vertical driving unit that moves individual slots which moved the lower guide plate, towards the upper guide plate of an upper part.

And the partition means is configured to have a frame, a plurality of horizontal partition members that divide the frame horizontally, a plurality of vertical partition members that are perpendicular to the horizontal partition members and divide the frame vertically, and a sliding plate arranged at a lower part of the frame, which folds as unit cells partitioned by the horizontal partition members and vertical partition members open and close downwardly and slides.

Further, a guide groove is formed at a lower part of the partition means whereby the dispensing means is slidably attached and detached.

And the dispensing means allow a dispensing slot corresponding with horizontal unit cells to be arranged and each vertical unit cell to be slidably attached and detached into a respective divided segment.

Further, the vertical partition member is configured to have a vertical plate with slots formed to be spaced in correspondence with the horizontal partition member, a perpendicular plate extending perpendicularly at both ends of the vertical plate, an extending plate extending horizontally in a direction opposing each other at the perpendicular plate, and a flat plate extending orthogonally to the extending plate to be connected with the driving means.

And an upper end of the vertical plate is formed to have an inclined surface in a thickness direction.

Further, the driving means is configured to have a driving rotary shaft arranged horizontally in a vertical direction to the partition means, that is operated by a handle, a driven rotary shaft arranged at a position facing the driving rotary shaft, a plurality of rotating bodies each coupled to the driving rotary shaft and driven rotary shaft, and a moving member connecting to each of the plurality rotating bodies.

And the rotary body is arranged in a number corresponding to the vertical partition member of the partition means.

Further, the rotating bodies increase in diameter towards an outer direction from the shaft.

And the diameters of the rotating bodies are in proportion to a distance moved horizontally by the vertical partition member connected to each rotating body.

Further, the powdered medicine dispensing apparatus is configured to further include a horizontal separating plate and a vertical separating plate whereby, out of the unit cells partitioned by the vertical partition members and horizontal partition members, only the unit cells where powdered medicine is injected and partitioned are distinguished and partitioned.

And the vertical separating plate differs in length according to the position of the horizontal separating plate which is positioned at the horizontal partition means.

Further, the dispensing means is configured to have a plurality of slots partitioned by the partition means, that enables divided powdered medicine to be dispensed towards the individual slot arranged below, a fixing unit fixing the slot on a belt, a roller and shaft for step-moving the slot vertically, a cover arranged at a lower part of the slot to open and close the lower part as it rotates by a hinge, and a hanging bar extended towards a side of the cover, which is pressed by a pressing bar according to a movement of the slot to open the cover.

And the individual slot is configured to have a slot storing powdered medicine divided and dropped from the dispensing means, a cover blocking a lower part of the slot, an opening means operating the cover to open and close the lower part of the slot, and a side fixing unit enabling the slot to be guided horizontally by the first horizontal driving unit.

Further, the opening means is configured to have a hinge rotatably connecting the cover to the slot, a link with a side coupled to the hinge side and a link shaft formed on the other side, a perpendicular bar rotatably connected to the link shaft, a pressing unit installed at an end part of the perpendicular shaft, and a guiding unit guiding the perpendicular bar in a state of being supported on the slot.

And the first and second horizontal driving units are configured to have a pressing unit pressing the individual slot horizontally, a belt with the pressing unit fixed, and a roller operating the belt.

Further, the first and second vertical driving units are configured to have a roller coupled to a shaft, a belt rotating by the roller, and a guiding unit coupled to the outer side of the belt, which seats the horizontally transferred individual slot.

And the auxiliary slot unit is configured to have a plurality of perpendicular shafts, an upper fixing bar installed at an upper part of the perpendicular shaft, a first spring positioned between a lower fixing bar installed at a position spaced with a predetermined spacing at the upper fixing bar, a guide bar installed at a perpendicular bar so that the guide bar is supported at an upper end of the first spring, and a pair of powdered medicine guiders rotatably installed on the guide bar, expand operating by the individual slot to guide powdered medicine to medicine wrapping paper.

Further, a second spring which is elastically supported in a direction opposite to each other on the powdered medicine guiders in connection with the guide bar is further provided.

And the second spring is formed to be less elastic than the first spring.

Further, a split sealing machine which is arranged in a proceeding direction of medicine wrapping paper supplied in a roll form to enable the medicine wrapping paper to be divided vertically is further provided in the powdered medicine dispensing apparatus.

And a powdered medicine dispensing apparatus, according to the present invention comprises a multilayered partition means having a frame with a space of predetermined size, that divides the frame horizontally and vertically to form unit cells for powdered medicine to be uniformly distributed; a first driving means connected to a vertically partitioning member of the multilayered partition means whereby a vertical spacing of a member is adjusted; and a second driving means which moves each of the multilayered partition means individually.

And the first driving means is arranged at a lower part of the frame and individually connected to a vertically partition member, whereby each is operated individually.

Further, a diameter of a rotating body is formed so that each of the first driving means operates proportionally to a distance moved by a vertical partition member.

And the multilayered partition means is configured to have a frame stacked with a plurality thereof and arranged to be slidable with each other, a plurality of horizontal partition members that divide the frame horizontally, a plurality of vertical partition members that divide in a vertical direction perpendicular to the horizontal partition members, and a bottom plate for controlling a bottom surface of a frame arranged at the lowermost part of the frame.

Further, the vertical partition member is configured to have a lower guide groove formed to have an inclined upper part and stepped lower part, and a first to third member formed to have a plurality of guide grooves in which the horizontal partition member is inserted into and slides along a length direction.

And an upper protrusion is formed closely contacting the lower guide groove at an inclined surface of the second and third members so that the vertical partition member may be guided as it moves in a length direction by closely contacting the lower guide groove.

On the other hand, as a powdered medicine dispensation packaging apparatus for packaging using a powdered medicine dispensing apparatus, it comprises a dispensing means arranged under a partition means to load powdered medicine partitioned into unit cells as it falls, a third driving means for lifting the dispensing means, an auxiliary slot unit provided under the dispensing means to open the upper part of the medicine wrapping paper by a falling force of the vertically moved distribution means and simultaneously inject powdered medicine stored in the dispensing means into medicine wrapping paper, and a plurality of split sealing machines for individually separating and packaging medicine wrapping paper in a state in which powdered medicine is injected.

### Advantageous Effects

According to the present invention, there are effects of significantly reducing the production cost of equipment to enable a more precise uniform dispensing of the powdered medicine while relying on half-manual work by a worker, allowing many distribution operations to be performed easily and speedily, and dispensing responsively according to an amount that is dispensed and an amount that is packaged.

Further, according to the present invention, through a semi-automatic method, split injected powdered medicine is easily packaged.

### BRIEF DESCRIPTION OF THE DRAWINGS

FIG. 1 is a plan view showing a powdered medicine dispensation packaging apparatus according to a first embodiment of the present invention.

FIG. 2 is a side view showing a powdered medicine dispensation packaging apparatus according to a first embodiment of the present invention.

FIG. 3 is a perspective view showing the vertical partition member shown in FIG. 1.

FIG. 4 is a perspective view showing a dispensing means according to the present invention.

FIG. 5 is a perspective view showing a horizontal separating means according to the present invention.

FIG. 6 is a perspective view showing a vertical separating means according to the present invention.

FIGS. 7 to 10 are operational state views showing the operation of a powdered medicine dispensation packaging apparatus according to a first embodiment of the present invention.

FIG. 11 is a front view showing a powdered medicine dispensation packaging apparatus according to a second embodiment of the present invention.

FIG. 12 is a plan view showing a powdered medicine dispensation packaging apparatus according to a second embodiment of the present invention.

FIG. 13 is a schematic diagram showing a dispensing means shown in FIG. 11.

FIG. 14 is a schematic diagram showing an individual slot shown in FIG. 12.

FIG. 15 is a perspective view showing a powdered medicine guider of an auxiliary slot unit shown in FIG. 12.

FIGS. 16 to 20 are operational state views showing the operation of a powdered medicine dispensation packaging apparatus according to a second embodiment.

FIG. 21 is a view showing a partition means of a powdered medicine dispensation packaging apparatus according to a third embodiment.

FIG. 22 is a view showing a vertical partition member shown in FIG. 21.

FIG. 23 is a view showing a first driving means shown in FIG. 21.

FIG. 24 is a schematic view showing a dispensing means and auxiliary slot unit according to a third embodiment of the present invention.

FIG. 25 is a view showing a dispensing means shown in FIG. 24.

FIG. 26 is a view showing an auxiliary slot unit shown in FIG. 24.

FIGS. 27 to 30 are operational state views of a powdered medicine dispensation packaging apparatus according to a third embodiment of the present invention.

### DETAILED DESCRIPTION OF THE EMBODIMENTS

Hereinafter, preferred embodiments of the present invention will be described in more detail with reference to the accompanying drawings. The embodiments of the present invention can be modified in various forms, and the scope of the present invention should not be construed as limited to the embodiments set forth below. The present embodiments are provided to describe the present invention in more detail to those skilled in the art to which the present invention pertains. Accordingly, the shape of each element shown in the figures may be exaggerated in order to emphasize a more clear description.

The terms first, second, etc. may be used to describe various components, but the components should not be limited by the terms. The terms are used only to distinguish one component from another.

The terminology used herein is for the purpose of describing particular embodiments only and is not intended to be limited the present invention. Singular forms include plural referents unless the context clearly indicates otherwise. In this application, the terms “comprises” or “having”, etc. are for specifying the presence of a feature, number, step, operation, component, or a combination thereof presented in the specification, and it should be understood that it does not pre-exclude the possibility of the presence or addition of one or more of other features, numbers, steps, operations, components or a combination thereof.

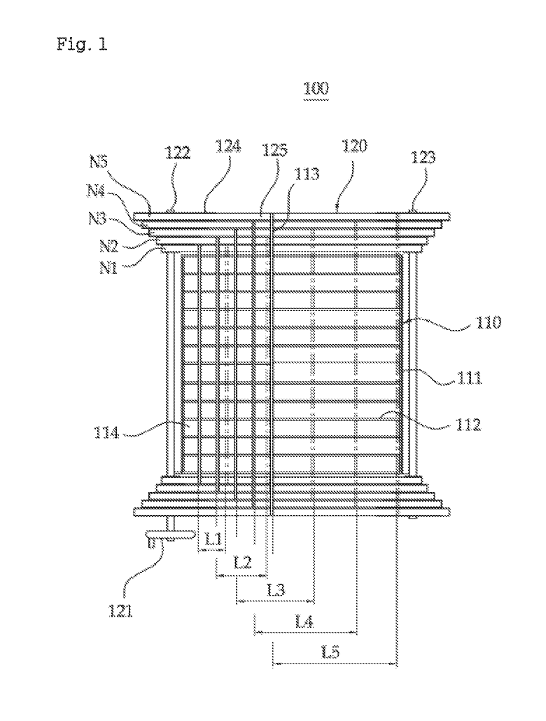

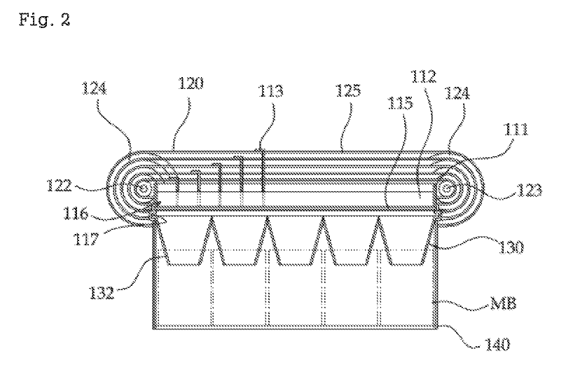

As shown in FIGS. 1 and 2, a powdered medicine dispensation packaging apparatus 100 according to a first embodiment of the present invention comprises a partition means 110, driving means 120, dispensing means 130, and a holding unit 140.

The partition means 110 is provided with a frame 111 having a predetermined size and is configured to divide the frame 111 horizontally and vertically to form unit cells 114 for powdered medicine to be uniformly distributed in the unit cells 114.

For this, a frame 111 in a rectangular form having a predetermined height and an open upper and lower part, a horizontal partition member 112 arranged evenly spaced in a horizontal direction in the frame 111 to divide the space inside the frame horizontally, a vertical partition member 113 arranged in a vertical direction of the frame 114 in plurality to divide vertically, and a sliding plate 115 arranged at a lower part of the frame 114 to open and close the lower part is comprised.

Further, a guide groove 116 guiding the sliding plate 115 and a guide groove 117 guiding the dispensing means 130 are formed respectively at the lower part of the frame 111.

In addition, the vertical partition member 113 is connected to a driving means 120 thereby partitioning unit cells 114, and horizontal spacing thereof is adjusted to allow powdered medicine that is injected in a unit cell to be uniformly distributed inside the unit cell.

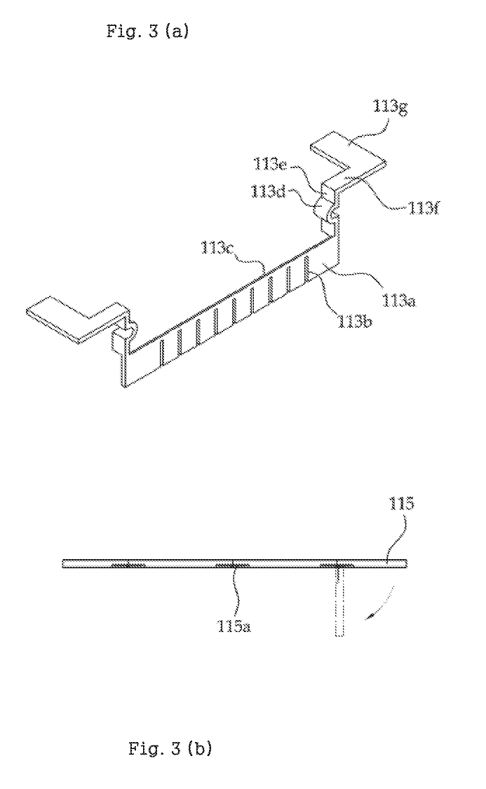

Further, the vertical partition member 113, as shown in FIG. 3a, is configured to have a vertical plate 113a, having slots 113b formed to be spaced in correspondence with the horizontal partition member and an inclined surface 113c at an upper surface inclined in a thickness direction, a perpendicular plate 113e extending perpendicularly at both ends of the vertical plate 113a, having an elastic member 113d formed which pressurizes the vertical plate 113a towards a sliding plate 116, an extending plate 113f extending horizontally in a direction opposite to each other from the upper end of the perpendicular plate 113e, and a flat plate 113g extending orthogonally from an end part of the extending plate 113f to be connected with a moving member.

Here, the inclined surface 113c is formed to prevent the vertical plate from being weakened by a slot 113b extending to an upper end while preventing powdered medicine that is injected from being piled at the upper end of the vertical partition member.

Further, the sliding plate 115 is provided with a hinge 115a so that the sliding plate may be folded at regular intervals as shown in FIG. 3b.

The driving means 120 is a component that is connected to the vertical partition member which divides the horizontal direction, to adjust the horizontal spacing of the member.

As a specific configuration of the driving means 120, it is configured to have a driving rotary shaft 122 arranged on one side of the frame 111, that is operated by a handle 121, a driven rotary shaft 123 arranged on the other side of the frame 111, that is linkage driven by a rotation force of the driving rotary shaft, a plurality of rotating bodies 124 having different diameters in a shaft direction, coupled to the driving rotary shaft 122 and driven rotary shaft 123, respectively, and a moving member 125 connecting the rotating bodies 124 to make them mutually linkage driven.

At the exterior circumference of the moving member 125, the vertical partition member 113 is arranged in a number corresponding to the moving member, allowing each of the connected vertical partition members to operate with a different moving distance by the rotation of the rotating body.

Further, each of the rotating bodies 124 have diameters proportional to the moving distance of each of the vertical partition members 113 inside the frame, so as much as the diameter gradually expands from the rotating body of N1 to the rotating body of N5, the moving distance of the vertical partition members connected to N1 to N5 respectively by a moving means each change from L1 to L5, so that the horizontal expansion spacing of the unit cells are made uniform.

For example, each rotating body 124 gradually increases in diameter from N1 to N5, and the moving distance of the vertical partition member 113 which is sequentially connected to N1 to N5 of the rotating body from the left side to the right side in reference to the drawings, are moved in proportion to the diameter of the rotating bodies. The moving distance moves as much as L1 by the rotation of N1, as much as L2 by the rotation of N2, and in this way of moving in distance, the moving distance increases from L1 to L5, so the diameter of the rotating bodies are to be correspondent thereto.

Accordingly, the unit cells 114 partitioned by the vertical partition member and the horizontal partition member are extended according to the movement interval, and a uniform space may be ensured.

The driving means 120 is described in the form of a belt in the drawing, but it may be operated by a gear method, and if it is configured to move the vertical partition member horizontally evenly spaced, then any of the sort may be included.

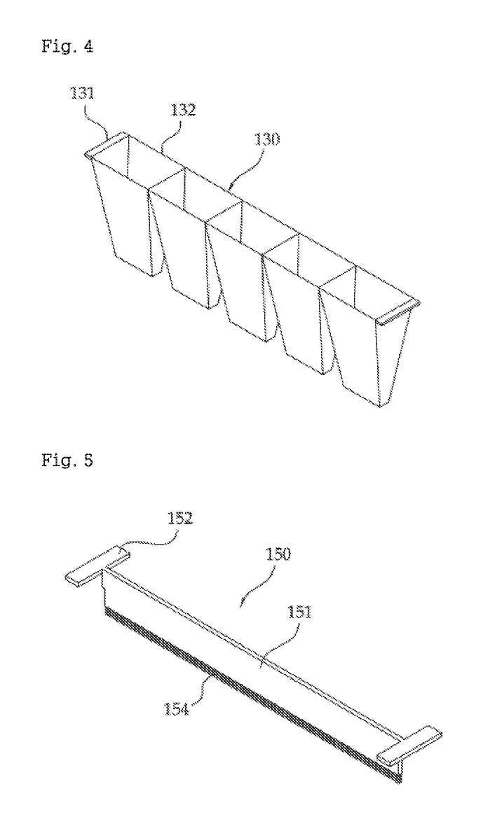

The dispensing unit 130, as shown in FIG. 4 is configured to have a dispensing slot 132 arranged in plurality, which has a predetermined size and a funnel shape that decreases in size from the upper part towards the lower part, and a sliding plate 131 to be slid and inserted along a guide groove 117 arranged at both ends of the dispensing slot 132 and formed on the frame 111.

The dispensing means 130 is arranged in a number corresponding to the spacing of the unit cells that divide the frame horizontally, and the unit cells that are divided vertically, are assembled in a block shape as to be adjusted according to the amount of powdered medicine to be dispensed and packaged.

That is, the dispensing means 130 is detachable in a cartridge manner according to the quantity of the unit cells in which powdered medicine is vertically divided.

The holding unit 140 is arranged at a lower part of the partition means 110 and is not shown in the drawings as a means to support a medicine bag located under the dispensing means 130, but may be guided from the partition means and coupled as a slidingly detachable structure.

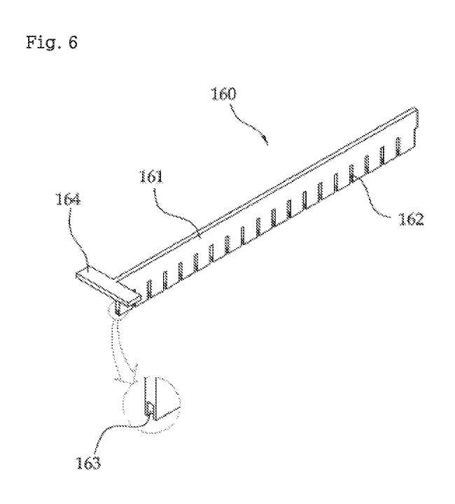

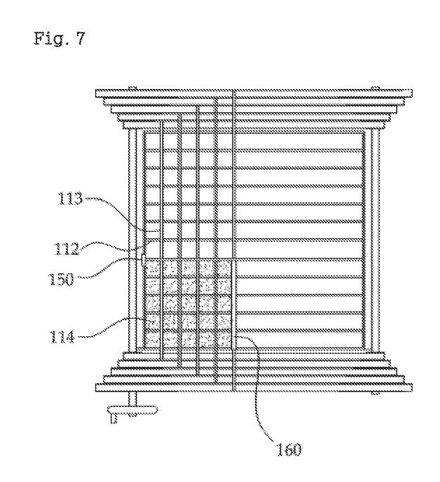

On the other hand, as shown in FIG. 5 and FIG. 6, a horizontal separating plate 150 and a vertical separating plate 160 are further provided.

The horizontal separating plate 150 is configured to have a horizontal plate 151 having a length corresponding with a horizontal spacing of the frame 111, a handle 152 arranged at both ends of the horizontal plate 151, and a gap blocker 154 arranged in a length direction at a lower part of the horizontal plate 151, and the gap blocker 154 may be in form of a sol or use urethane, silicone, etc. that has excellent elasticity.

That is, the horizontal separating plate 150 is arranged having a corresponding length with the horizontal partition member at the upper part of the horizontal partition member.

The vertical separating plate 160 is configured to have slots 162 corresponding to the number of horizontal partition members, and a vertical plate 161 having a groove 163 formed in a length direction to be fixed to the vertical partition member in a clip form.

Further, the vertical separating plate 160 includes a plurality thereof that is formed with different vertical length according to the location the horizontal separating plate 150 is partitioned.

For example, the horizontal separating plate 150 and the vertical separating plate 160 are configured to separate the partitioned unit cells 114 according to the number of powdered medicine being divided to separate them from unit cells not being used.

Here, the number of vertical partition members is illustrated as 5, and the number of horizontal partition members is illustrated as 11, but it is noted that the number of vertical partition members and horizontal partition members may be increasingly formed according to the number of packages of powdered medicine, and it is also noted that the rotating bodies of the driving means is correspondingly increased.

Hereinafter, the operation state of the first embodiment of the present invention will be described with reference to the accompanying drawings.

First, a dispensing means 130 which is blocked in the form of a cartridge to match the quantity of medicine to be packaged, is slidingly inserted into the lower part of the partition means and then, as shown in FIG. 2, a necessary amount of medicine wrapping paper (MB) is arranged on the holding unit 140 to enable the opening of each medicine wrapping paper to be inserted in the dispensing slot of the dispensing means 130.

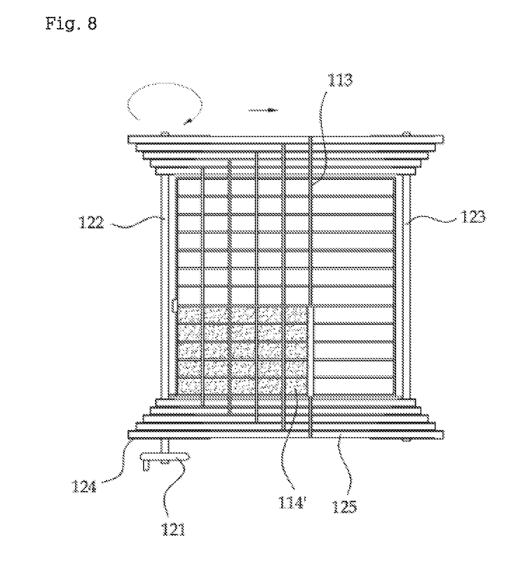

Then, as illustrated in FIG. 7, the unit cell 114 is separated by using the horizontal separating plate 150 and vertical separating plate 160 as needed and powdered medicine (PW) is injected in the separated unit cell 114. At this time, the horizontal separating plate 150 is located on an upper part of the horizontal partition member 112, and the vertical separating plate 160 is closely arranged on a side of the vertical partition member arranged at the very right side out of the vertical partition members 113 in reference to the drawing, and an end part of a side of the vertical separating plate is closely arranged to a side of the horizontal separating plate.

Further, medicine that is mixed according to a prescription that is pulverized in a large number and arranged is used as the powdered medicine.

If the amount of powdered medicine to be injected is large, horizontal separating plate is moved towards another horizontal partition member to partition the horizontal separator plate, and a vertical separating plate corresponding thereto is arranged on the vertical partition member side. That is, the vertical separating plate is prepared individually in plurality to have a length corresponding to the spacing of the divided horizontal partition member.

In this state, if the powdered medicine (PW) is injected into the separated unit cells 114, the injected powdered medicine is piled up to have a higher height than the one partitioned by the horizontal partition member and vertical partition member, so this must be adjusted so that powdered medicine is uniformly distributed to the unit cells.

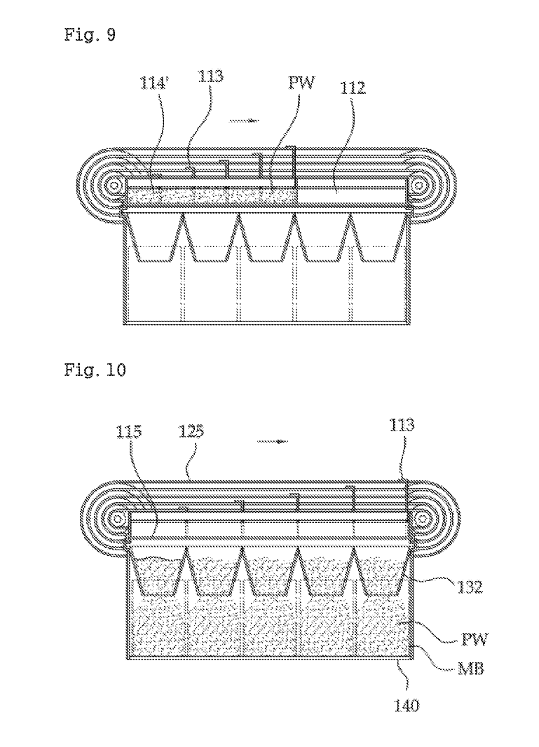

For this, as shown in FIG. 8, the handle 121 is operated so that as the driving rotary shaft 122 and the driven rotary shaft 123 are rotated the connected moving means 125 is moved in the rotating direction.

At this time, a vertical partition member 113 is connected to the moving means 125 so the vertical partition member moves as much as the moving distance of the moving means.

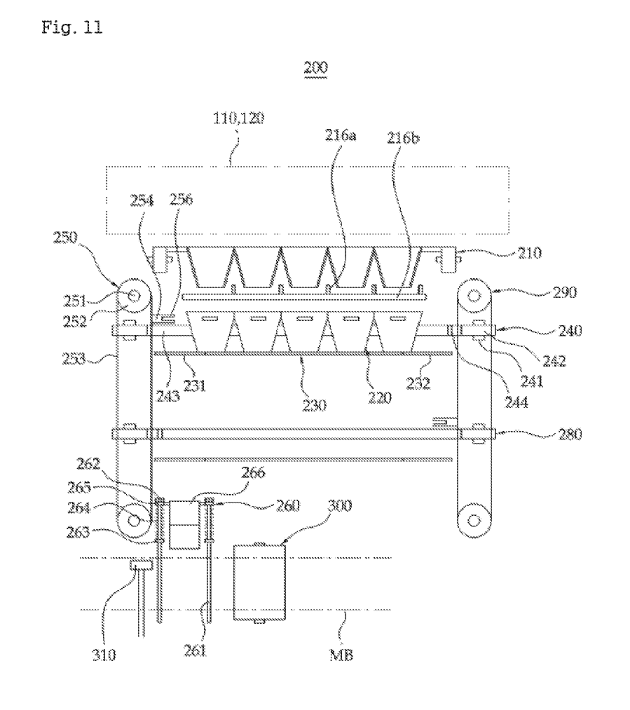

Further, each of the vertical partition members is moved in different distances by rotating bodies having different diameters, so the partitioned unit cells are expanded with uniform spacing, and powdered medicine (PW) as shown in FIG. 9 for the expanded unit cells 114′ is horizontally aligned with the upper end of the unit cell 114′

According to another method, when the total volume of the powdered medicine is known, the spacing of the vertical partition members at which the powdered medicine becomes aligned horizontally with the upper end of each unit cell may be calculated by a simple calculation, and the vertical partition member is moved at the same interval and then the powdered medicine is injected, and the upper part of the partition member is evened out. At this time, it is possible to install a scale along the vertical direction to accurately identify the spacing between the vertical partition members.

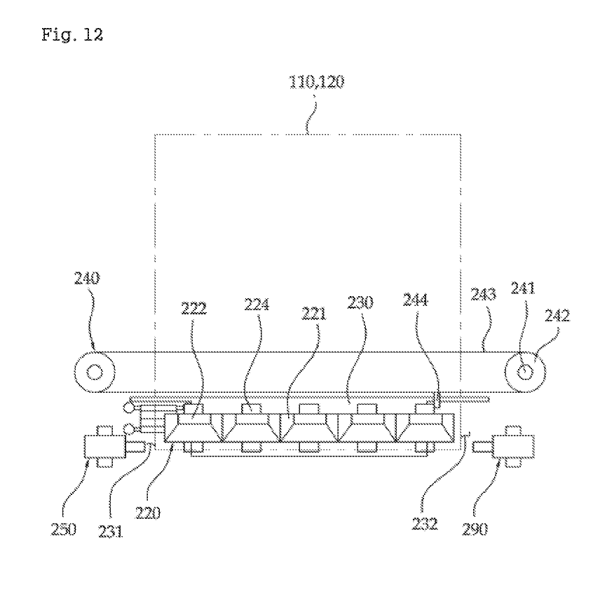

Then, as shown in FIG. 10, if the moving means 125 is moved by rotating the rotating body to inject a uniformly divided powdered medicine to the medicine wrapping paper, each of the connected vertical partition members 113 are vertically aligned with the unit dispensing slots 132 arranged underneath.

In this state, when the sliding plate 115 disposed at the lower part of the partition means is slid out along the guide groove 116, the powdered medicine placed in the unit cell is naturally introduced towards the medicine wrapping paper (MB) arranged respectively along the dispensing slot 132. At this time, the sliding plate 115 is arranged with a hinge 115a at regular intervals in a sliding direction so that the sliding plate is lowered downward when the sliding plate is slid off, thereby minimizing the space occupied by the sliding plate.

When the powdered medicine is injected into the medicine wrapping paper, uniformly distributed powdered medicine is stored in each medicine wrapping paper when the powdered medicine is separated from the dispensing slot.

At this time, when the holding unit 140 is enabled to slide off from the partition means, it is possible to easily perform a packaging operation by separating a medicine wrapping paper in a state inserted into the dispensing slot at once.

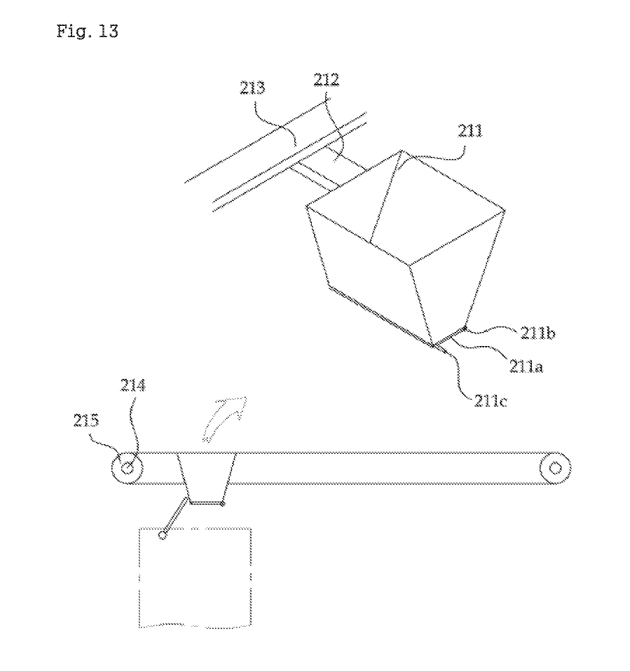

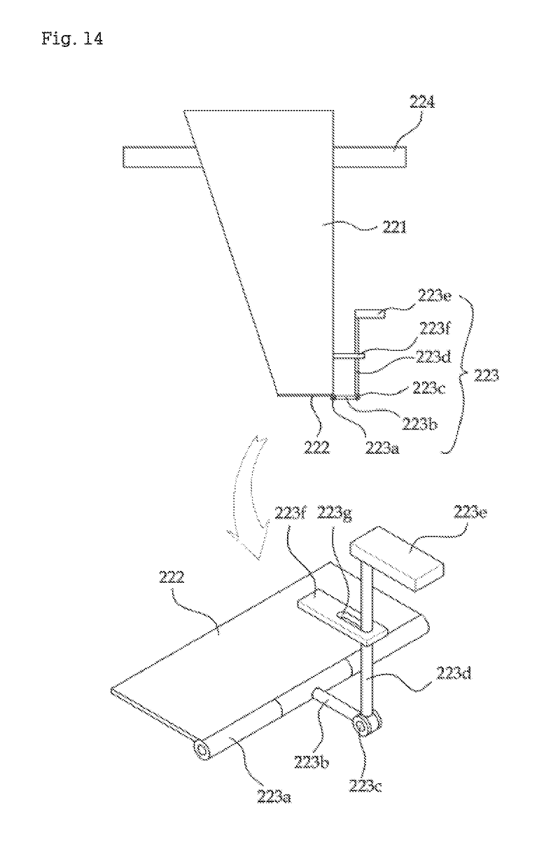

As shown in FIGS. 11 and 12, the powdered medicine dispensation packaging apparatus 200 according to a second embodiment of the present invention comprises a partition means 110, driving means 120, a dispensing means 210, an individual slot 220, an upper guide plate 230, a first horizontal driving unit 240, a first vertical driving unit 250, an auxiliary slot unit 260, a lower guide plate 270, a second horizontal driving unit 280 and a second vertical driving unit 290.

The partition means 110 and the driving means 120 use the structure used in the first embodiment, and thus the detailed description thereof will be omitted.

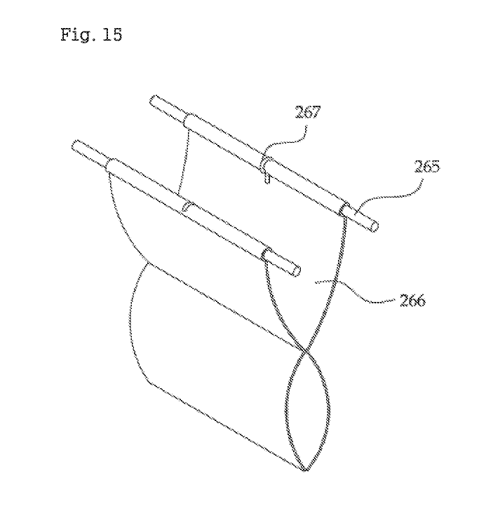

As shown in FIG. 13, the dispensing unit 210 is provided under a partition means 110 and a driving means 120, and as a component to sequentially store the powdered medicine divided into unit cells by the partition means and driving means, is arranged to have a width and area corresponding to the lower area of the partition means and driving means so a roller 215 is driven by a shaft 214 connected to a motor (not shown), and a plurality of slots 211 are coupled to a fixing unit 212 on a belt 213 wound on the roller 215. The slot 211 is preferably arranged in a number corresponding to the horizontal direction of the unit cells partitioned by the partitioning means.

Further, a pressing bar 216a capable of opening the lower part of each slot 211 under the dispensing means 210 is arranged inclining in the slot direction while being orthogonal to a horizontal bar 216b, wherein the slot 211 is configured to have a cover 211a pressurized by the pressing bar 216a to open or close the lower part of the slot, a hinge 211b that turns the cover 211a, and a hanging bar 21c at the pressing bar, which is caught by the pressing bar according to a movement of the slot thereby opening the cover.

The individual slots 220 are located under the dispensing means 210, and a quantity corresponding to the number of slots of the dispensing means is arranged to be pressed and moved individually by the first horizontal driving unit and is separately moved towards the first vertical driving unit.

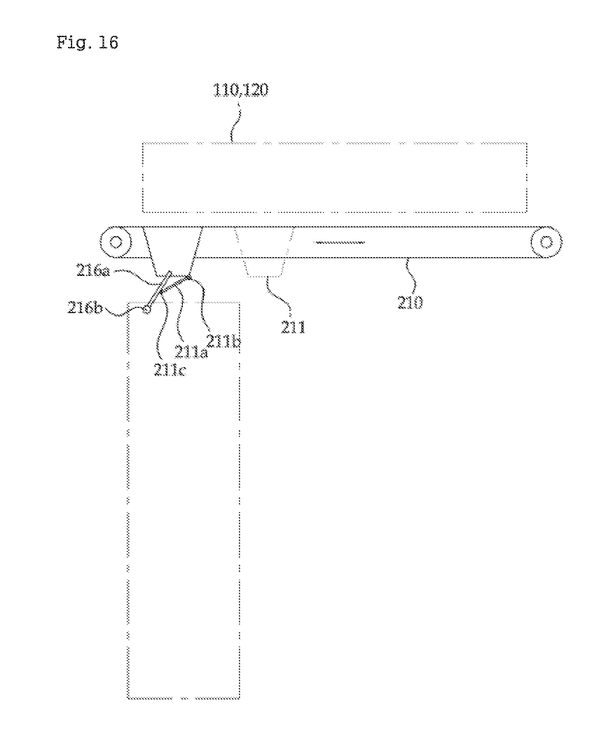

Further, the separate slot has an open upper part and a lower part that is opened and closed by the cover 222, and as shown in FIG. 14, is configured to have a slot 221 having a gradually narrowing width gradually from the upper part to the lower part, an opening means 223 connected to the cover 222 and performing an operation for opening and closing the cover 222 from the slot, and a side fixing unit 224 arranged in a position opposite to the slot 221 side.

And the opening means 223 is configured to have a hinge 223a rotatably connecting the cover 222 and the slot 221, a link 223b with a side fixed to the hinge 223a, provided with a link shaft 223c on its end in a state where it is extended to a certain length, a perpendicular bar 223d rotatably connected to the link shaft 223c and extended to a certain length, a pressing unit 223e extending orthogonally at an end part of the perpendicular bar 223d, which is pressurized by the auxiliary slot unit described below, and a guiding unit 223f having a guiding groove 223g to guide the perpendicular bar 223d when moving vertically. The guiding unit 223f is connected to a side of the slot 221.

The upper guide plate 230 is arranged on the lower part of the individual slots 220 to guide the individual slots 220 and has a cutting hole 231, 232 cut on both ends to a size big enough to allow the individual slots 220 to pass through.

The first horizontal driving unit 240 is configured to horizontally move the individual slots 230, wherein a roller 242 installed to a shaft 244 with a spacing corresponding to the moving distance of the individual slots is arranged, and a belt 243 is wound on the roller 242 and operated, and a pressing unit 241 is provided on the belt 243 that pressurizes and pushes the individual slot horizontally.

That is, the first horizontal driving unit 240 is configured to horizontally move the pressing unit 241, and move the individual slots in a state where they are seated on the upper guide plate from the side of the second vertical driving unit to the side of the first vertical driving unit, wherein the individual slots are pushed stepwise so the individual slots may be discharged one by one towards the cutting hole 231 of the upper guide plate, by the first vertical driving unit.

The first vertical driving unit 250 is configured to have a roller 252 connected to a shaft 251 which is spaced apart evenly, a rotating belt 253 wound on the roller 252, and a guiding unit 254 which is fixed to the belt 253, and a coupling groove 255 in which a side fixing unit of the individual slot is inserted and seated is formed on the guide plate 254.

That is, the first vertical driving unit is configured to grab the individual slots which move by the first horizontal driving unit to move to the auxiliary slot unit underneath.

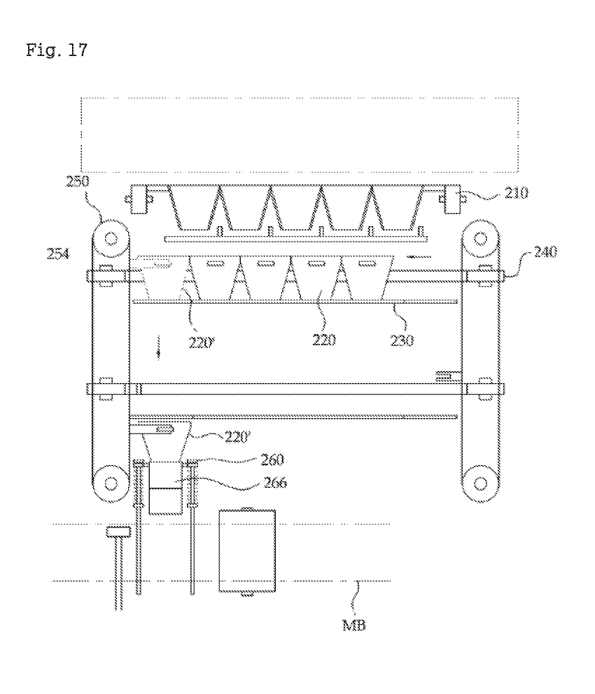

The auxiliary slot 260 is arranged at a lower side of the first vertical driving unit 250 as shown in FIG. 15, to guide the powdered medicine stored in the individual slots 220 moved by the first vertical driving unit 250 to a medicine wrapping paper, wherein it is configured to have a pair of perpendicular shafts 261 which are arranged at both sides of the medicine wrapping paper (MB) moving the lower part in the horizontal direction, an upper fixing bar 262 fixed to the upper end of the perpendicular shaft 261, and a lower fixing bar 263 arranged at a position spaced apart with a certain spacing from the upper fixing bar 262, a first spring 264 arranged between the upper fixing bar and the lower fixing bar, a guide bar 265 inserted into a perpendicular shaft to be supported by the first spring 264, and a powdered medicine guider 266 rotatably coupled to the guide bar 265.

Here, the powdered medicine guider 266 is arranged to have a curved shape as a pair, and a second spring 267 is further included between the powdered medicine guider and guide bar so that the pair of powdered medicine guiders 266 are pressed in a direction opposite to each other.

It is preferable that the second spring 267 has a relatively strong elasticity relative to the first spring 264. This is to allow the powdered medicine guider to be opened by pressurizing the individual slot after the first spring is first compressed and constantly compressed by the pressing force when the powdered medicine guider is pressurized by the individual slots entering the upper part.

The lower guide plate 270 is a means to guide the individual slots when moving horizontally to move back to the upper guide plate after the individual slots drop the powdered medicine into the medicine wrapping paper, wherein a cutting hole 271 cut so that the individual slot may move towards the auxiliary slot unit with a length corresponding to the upper guide plate is formed on one side.

The second horizontal driving unit 280 and the second vertical driving unit 290 are arranged in a position corresponding to the first horizontal driving unit 240 and the first vertical driving unit 250, respectively, and the description thereof is omitted.

According to the second embodiment of the present invention, a split sealing machine 300 which is neighboring the auxiliary slot unit 260 while being arranged on the side of the proceeding direction of the medicine wrapping paper (MB) to allow the cartridge to be divided vertically, is further arranged to enable the powdered medicine injected in medicine wrapping paper to be packaged in divided areas.

Further, the medicine wrapping paper is guided by the guide roller 310 in the form of a roll, and passes between the auxiliary slots, and stores a powdered medicine that is dropped from the auxiliary slot.

Here, the dispensing means, the first horizontal driving unit, and the second horizontal driving unit, the first vertical driving unit and the second vertical driving unit are respectively operated by a motor (not shown) connected to a shaft, and the motor is not shown, but is controlled by a control unit for controlling each operation.

Hereinafter, the operation state of the second embodiment of the present invention will be described with reference to the accompanying drawings.

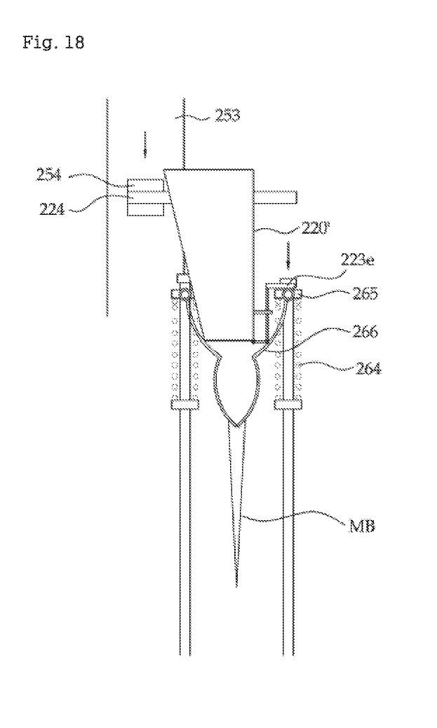

First, as in the first embodiment of the present invention, a partition means 110 and a driving means 120 is used for dividing the powdered medicine into unit cells, and then as shown in FIG. 16, the lower part of divided powdered medicine is opened stepwise to allow the divided powdered medicine to be moved to a slot 211 of a dispensing means 210. At this time, in the present embodiment, the distribution means is moved vertically from the lower part of the partition means and driving means so that the powdered medicine is separated, but on the other hand, an entire partition means and driving means may move stepwise and the medicine may be dropped by the dispensing unit.

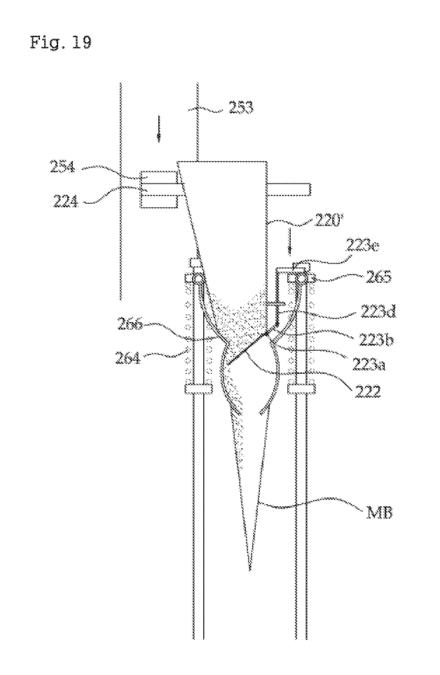

The powdered medicine injected to the dispensing means is made to be present in a slot closed by a cover 211a, and a hanging bar 211c arranged in the cover according to the movement of the slot is caught by a pressing bar 216a and is turned by a hinge 211b to be slowly opened to allow the powdered medicine to be dropped towards the individual slots 220 arranged underneath to store the powdered medicine inside each individual slot. Then, as shown in FIG. 17, the first horizontal driving unit 240 is operated to push the individual slots 220 to the first vertical driving unit 250, thereby enabling the individual slots 220′ of the front end of the unit individual slots to be connected to the guiding unit 254 of the first vertical driving unit 250.

That is, the dispensing means is able to inject the powdered medicine from the dispensing means in a stepwise manner as it is moved towards the powdered medicine of the state stored in the unit cells, and are opened by a pressing bar arranged on the lower part of the individual slots to allow the powdered medicine to be dropped into individual slots.

In this state, the first vertical driving unit 250 is operated to move the individual slots 220′ of the grabbed state to a lower side and move to the auxiliary slot unit 260 to allow the individual slots 220′ to be located on the powdered medicine guider 266 side of the auxiliary slot unit 260.

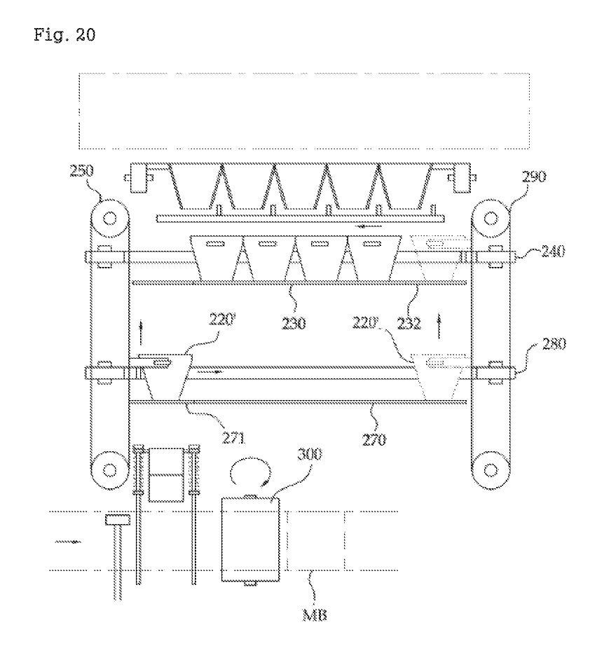

Next, as shown in FIG. 18, when the individual slot is lowered by operating the first vertical driving unit 250, the pressing unit 223e of the opening means 223 coupled to the individual slots 220′ pushes the guide bar 265 and the pressurized guide bar compresses the first spring 264 and is lowered so the lower end of the powdered medicine guider 266 is inserted between the medicine wrapping paper (MB), making the gap in between the medicine wrapping paper to be spaced apart from each other.

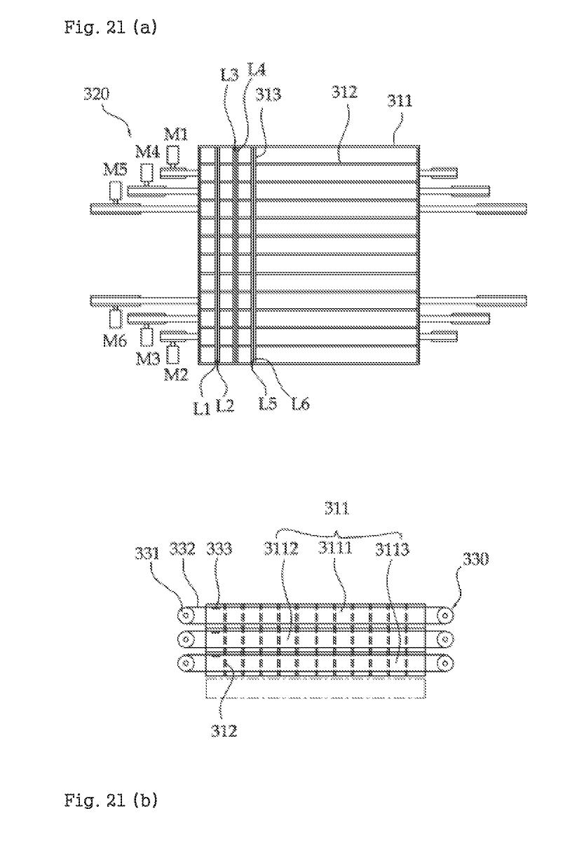

Thereafter, as shown in FIG. 19, by the individual slots that descend when the compressive force generated by the continuous compression of the first spring 264 is stronger than the spring force of the second spring, powdered medicine guider 266 is opened apart oppositely from each other and the medicine wrapping paper becomes even more spaced apart while a cover 222 of the lower part of the individual slots is opened by an operation of a link and a perpendicular shaft of an opening means of a pressed state, so that the powdered medicine that used to be stored is dropped and stored in a medicine wrapping paper.

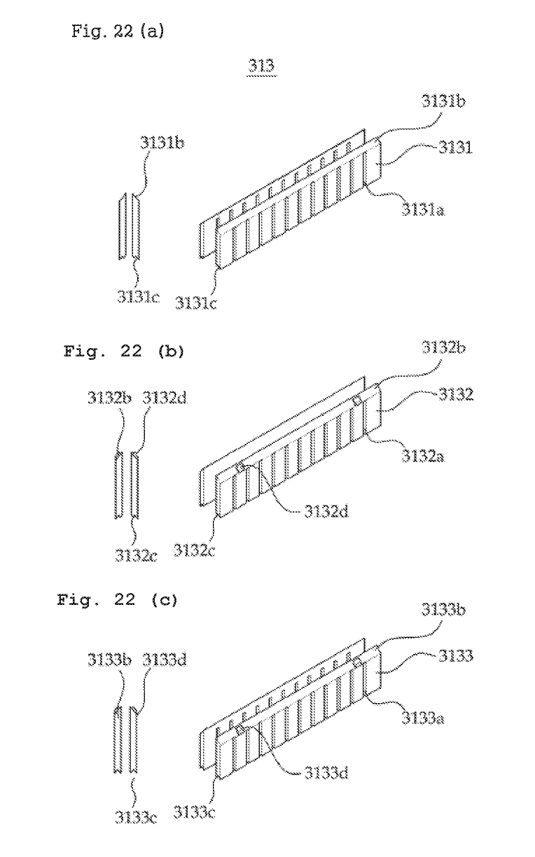

After dropping the powdered medicine from the individual slots, as shown in FIG. 20, the medicine wrapping paper is horizontally moved, while simultaneously the stored powdered medicine is partitioned by using the split fusion machine 300.

Further, the individual slots 220′ to which the dropping of powdered medicine is finished, operates the first vertical driving unit 250 in an upper direction to pass through the cutting hole 271 of the lower guide plate 270 while simultaneously operating a second horizontal driving unit 280 to move while being guided by the lower guide plate 270 towards the second vertical driving unit 290, and then by the second vertical driving unit 290 passing through the cutting hole 232 of the upper guide plate 230 of the upper part and may be positioned in the first horizontal driving unit.

Then, the first horizontal driving unit operates a movement that moves the individual slots horizontally again to move the individual slots to be located under the distribution unit.

This operation is repeatedly performed and the powdered medicine, which is divided by the partition means, can be injected into a continuous process.

As described above, the present invention may be able to correspond to an appropriate amount required by the patient as well as allow quick uniform separation of the powdered medicine to be divided, thereby obtaining high efficiency at low cost in a hospital dealing with a large amount of powdered medicine.

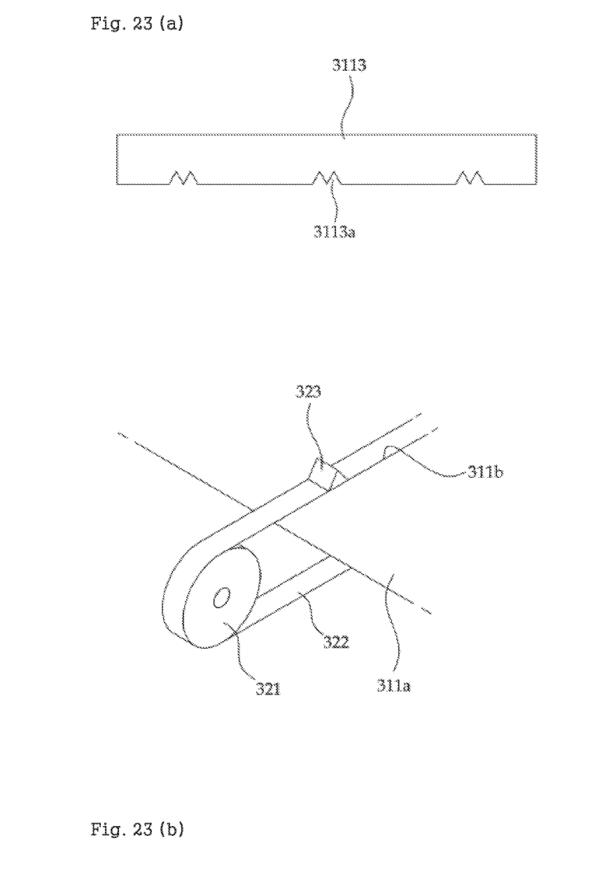

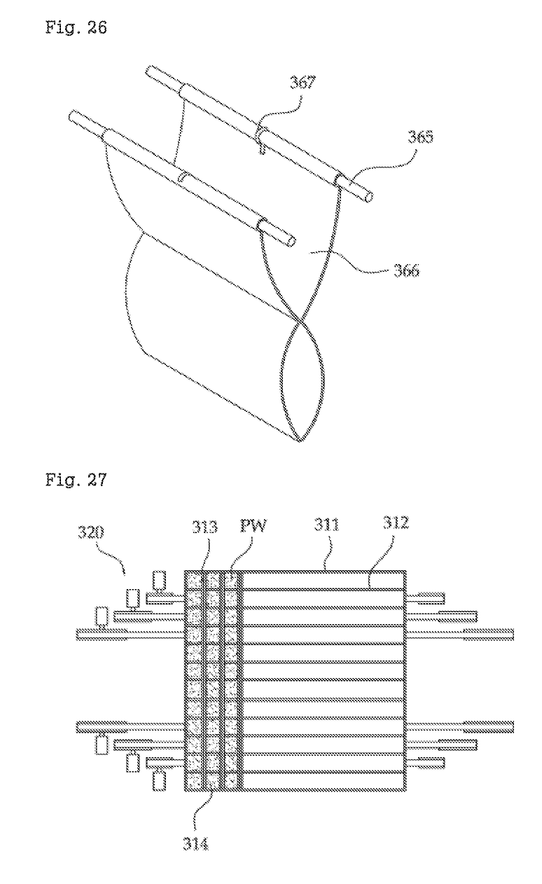

As shown in FIGS. 21 and 24, the powder dispensing packaging apparatus 300 according to a third embodiment of the present invention comprises a partition means 310, a first driving means 320, a second driving means 330, a dispensing means 340, a third driving means 350, an auxiliary slot unit 360, and a split sealing machine 370.

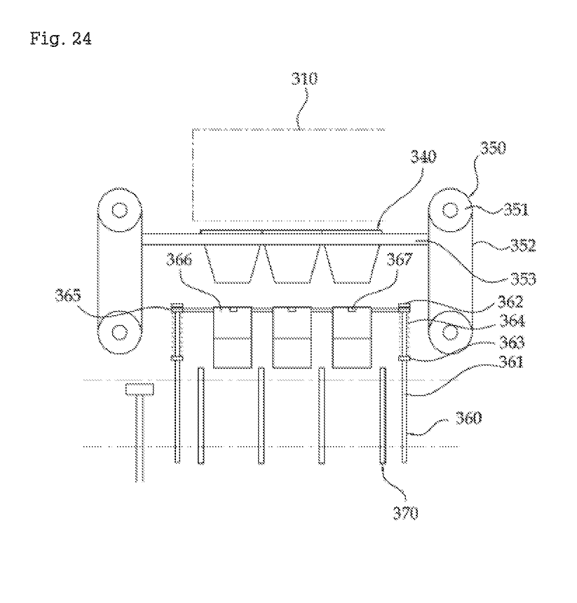

The partition means 310 comprises a frame 311 which is formed in a predetermined space by four closed surfaces and is stacked in plurality layers, as shown in FIGS. 21 to 23, a horizontal partition member 312 which divides the horizontal direction inside the frame 311 into even intervals, a plurality of vertical partition members 313 arranged in a direction perpendicular to the horizontal partition member 312, and a bottom plate 311a which controls the bottom surface of the frame arranged at the lowermost side of the frame.

The horizontal partition member 312 and the vertical partition member 313 are arranged to form a unit cell 314 partitioned in a frame so that a predetermined amount of powdered medicine is stored in the unit cells 314.

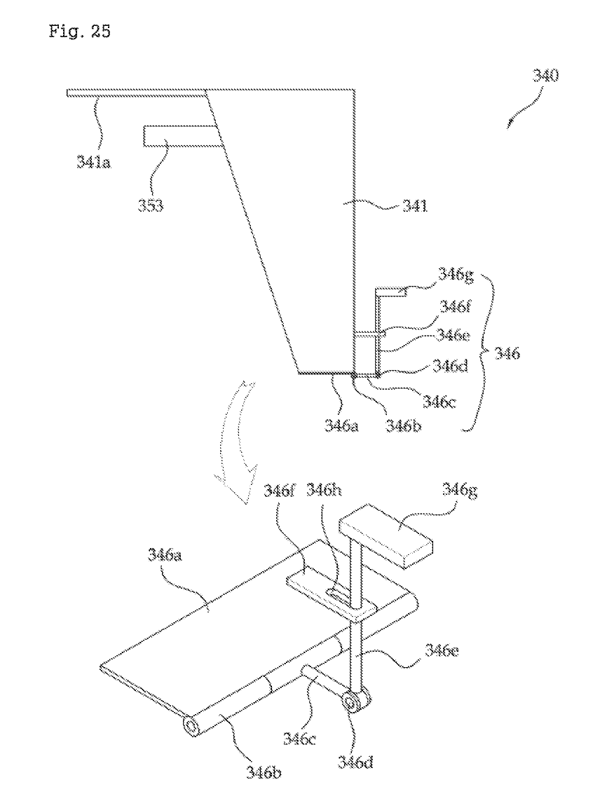

The horizontal partition members 312 are provided individually on each of a plurality of frames 3111, 3112, 3113 stacked in plurality layers, to be able to move together with each frame as it is operated individually, and as shown in FIG. 23, a guide groove 3113a is formed on a lower surface of a frame 3113 arranged on the lowermost layer out of each frame stacked in plurality layers so that each unit cell is expanded so when vertically moving, a holding protrusion 323 may pass in a state where powdered medicine is uniformly distributed.

The vertical partition member 313 is configured to have a first to third members 3131, 3132, 3133, and the first member 3131 comprises a guide groove 3131a formed to be evenly spaced along a length direction in the form of a plate having a certain length, an inclined surface 3131b formed on the upper surface thereof, and a lower guide groove 3131c formed on the lower surface thereof, and the second member 3132 comprises a guide groove 3132a formed to be evenly spaced along a length direction in the form of a plate having a certain length, an inclined surface 3132b formed on the upper surface thereof, a lower guide groove 3132c formed on the lower surface thereof, and an upper protrusion 3132d formed on a side of the inclined surface 3132b formed in plurality, and the third member comprises a guide groove 3133a formed to be evenly spaced along a length direction in the form of a plate having a certain length, an inclined surface 3133b formed on the upper surface thereof, a hanging groove 3133c formed on the lower surface thereof, and an upper protrusion 3133d formed on a side of the inclined surface 3133d in plurality.

Further, the first through third members 3131, 3132, 3133 are provided, stacked on each of the multilayered frames 311, and the first member slides along the upper surface of the second member if the frame 3111 of the uppermost layer moves when the multilayered frame is individually operated by the second driving member, and the second member slides along the upper surface of the third member and the frame 3113 of the lowermost layer moves and is separated from the bottom plate when the frame 3112 of a middle layer moves.

The first driving means 120, as shown in FIG. 23 is configured to have a rotating body 321 arranged at the lowermost frame 3113 of the frame 311 and connected via a shaft to operate, an endless track 322 which surrounds the rotating body 321 and moves by the rotation of the rotating body, and a hanging protrusion 323 which is arranged on one side of the upper surface of the endless track 322 to be inserted into the lower guide groove 3133c formed on the third member 3133 of the lowermost layer out of the vertical partition member 313.

Further, the first driving means 320 moves the third member as an endless track 322 operates between the grooves 311b formed on the bottom plate 311a to change the sizes of the unit cells dividing the frame.

Here the first driving means 320 is arranged in a number corresponding to a plurality of vertical partition members 313 forming unit cells as it moves horizontally to individually operate each vertical partition member, and a diameter of the rotating body is formed to allow each of the vertical partition members to operate in proportion to the distance moved.

That is, the first driving means 320 performs an operation for individually moving a plurality of vertical partition members to a predetermined length in a horizontal direction.

For example, when the first driving means 320 are individually connected to the vertical partition members, the first driving means referred to as M1 to M6 respectively, and the vertical partition members referred to as L1 to L6, respectively, they are connected in a manner in which M1 and L1 are connected, and M2 and L2 are connected, and the moving distance of L2 is moved farther than L1, and thus the rotating body may have a corresponding diameter thereto. In such a way, the diameter of the rotating body is differed from each other so as to perform the operation of M1 to M6 to correspond to a moving distance of L1 to L6, and apart from this, a measurement means (not shown) capable of measuring the number of rotations of the rotary body is provided whereby the moving distances of the vertical partition members may be adjusted by varying the number of rotations of a motor in a rotating body with a same diameter.

The second driving means 330 is configured to have a rotating body 331 arranged at both sides of the frame horizontally, an endless track 332 which surrounds the rotating body and operates by the rotating body, and a bracket (not shown) for individually connecting the endless track 332 to the respective frames 3111, 3112, 3113.

That is, the second driving means 330 is arranged in a number corresponding to each frame that is stacked and performs an operation of moving the frame in a vertical direction.

Here, the first driving means 320 is described in the form of a belt in the drawing, but it may be operated by a gear method, and if it is configured to move the vertical partition member horizontally evenly spaced, then any of the sort may be included, and it is described to be operated by the handle but it is also possible to be connected to a motor and such to be operated.

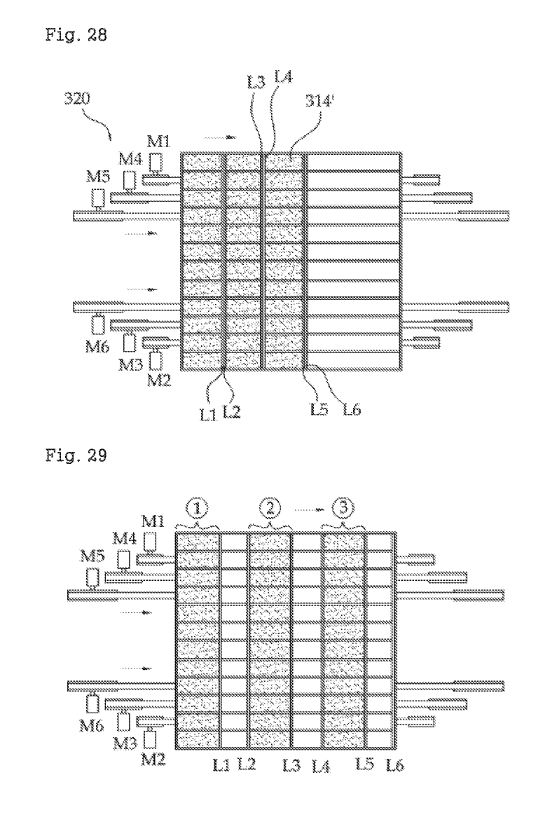

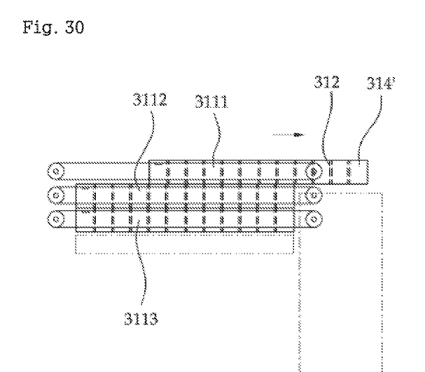

The dispensing means 340 is located under the partition means 310 as shown in FIGS. 24 and 25, and a plurality thereof is arranged to have spacing which corresponds with the spacing of the unit cells partitioned by a the vertical partition members. A storage slot 341 having an open upper part and a lower part which is opened and closed by a cover 346a, formed to decrease gradually more towards the bottom part, to store powdered medicine that is partitioned from the unit cells, and an opening means 346 which is connected to the cover 346a and performs an operation for opening and closing the cover 346a from the storage slot 341 is configured.

The opening means 346 is configured to have a hinge 346b for rotatably connecting the cover 346a and the storage slot 341, a link 346c which a side thereof is fixed to the hinge 346b and has a link shaft 346d in a state extended to a certain length on an end, a perpendicular bar 346e which is rotatably connected to the link shaft 346d and has a certain length extended in a vertical direction, a pressing plate 346g which extends orthogonally at the end of the perpendicular bar 346e and is pressed by an auxiliary slot unit which will be described below, and a guide unit 346f having a guide groove 346h formed to guide the perpendicular bar 346e when moving in a vertical direction. The guide unit 346f is connected to a side of the storage slot 341.

The third driving unit 350 is arranged in a vertical direction and configured to have a plurality of rotating bodies 351 arranged respectively on both lateral sides of the dispensing means 340, an endless track 352 which surrounds each rotating body 351 and operates to be connected vertically, and a bracket 353 for connecting the endless track 352 and the dispensing means 340.

The auxiliary slot unit 360 is arranged under the dispensing means 340 to be operated by the dispensing means 340 moving downward, as shown in FIG. 24, a pair of perpendicular shafts 361 which are arranged at both sides of the medicine wrapping paper (MB) moving the lower part in a horizontal direction, an upper fixing bar 362 fixed on the upper end of the perpendicular bar 361 and a lower fixing bar 363 arranged at a position spaced apart with a certain spacing from the upper fixing bar 362, a first spring 364 arranged between the upper fixing bar and the lower fixing bar, a guide bar 365 inserted into a perpendicular shaft to be supported by the first spring 364, and a powdered medicine guider 366 rotatably coupled to the guide bar 365.

Here, the powdered medicine guider 366 is arranged to have a curved shape as a pair in group in a number corresponding to the dispensing means 340 and storage slot 341, and a second spring 367 is further included between the powdered medicine guider and guide bar so that the pair of powdered medicine guiders 366 are pressed in a direction opposite to each other.

It is preferable that the second spring 367 has a relatively strong elasticity relative to the first spring 164. This is to allow the powdered medicine guider to be opened by pressurizing the individual slot after the first spring is first compressed and constantly compressed by the pressing force when the powdered medicine guider is pressurized by the individual slots entering the upper part.

The split sealing machine 370 is arranged between a plurality of powdered medicine guiders 366 arranged evenly spaced in the proceeding direction of the medicine wrapping paper and configured to moves towards the medicine wrapping paper to seal the medicine wrapping paper using heat or high frequency waves when powdered medicine is injected in the medicine wrapping paper, wherein a general sealer for sealing medicine wrapping paper and the like is used.

Hereinafter, the operation state of the third embodiment of the present invention will be described with reference to the accompanying drawings.

According to the present invention, the horizontal sections of the unit cells 314 are described as three in number.

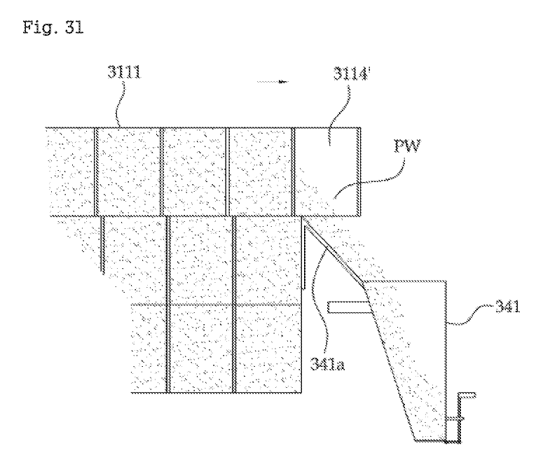

The powdered medicine filled in the unit cells, must change the volume of the unit cells according to a dose since the powdered medicine corresponding to a single dose is accommodated in one unit cell, and the volume of the unit cells must be changed through the movement of the vertical partition member and the capacity of the powdered medicine being filled in each unit cell must be uniform. For this, as shown in FIG. 27, a predetermined amount of powdered medicine (PW) is injected and filled in a separated space by the unit cells 314 partitioned to be evenly spaced inside a frame 311 by horizontal partition members 312 and vertical partition members 313.

In the multilayered frame, the lowermost frame and the intermediate frame are in a state completely filled with the powdered medicine, but at the uppermost frame it is in a piled up state and since the volume spacing of the unit cells don't meet the capacity of one dosage, the uniform distributions of the powdered medicine has not been performed on all of the unit cells.

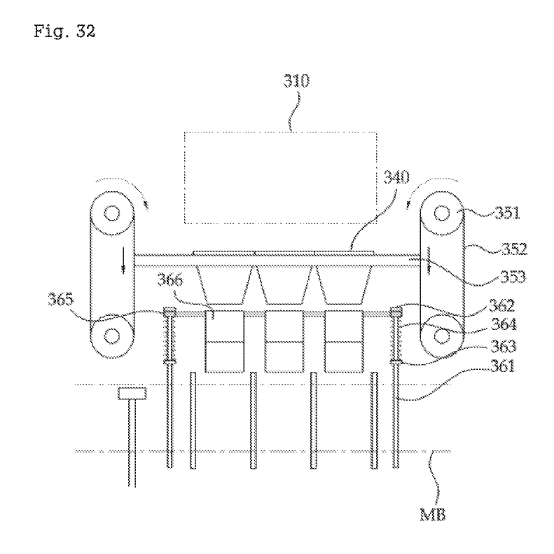

In this state, to uniformly distribute in respect to each unit cell of the powdered medicine, as shown in FIG. 28, the first driving means 320 is operated to move the vertical partition member 313 in a horizontal direction to a certain extent.

At this time, the first driving means 320 are divided into M1 to M6 and are individually connected to each of the vertical partition members distinguished as L1 to L6, so that the moving distance of L1 to L6 is different depending on the operation of M1 to M6.

That is, in order to uniformly distribute the powdered medicine in the unit cells, L1 and L2, L3 and L4, L5 and 16 are in close contact respectively, and M1 to M6 are operated respectively, so that L3 and L4 is moved twice as much as the distance L1 and L2 moved, and L5 and L6 are moved four times as much in distance. At this time, the operation of the first driving means is operated by a control signal of a control unit (not shown).

Shown here is, the frame when seen from a plan view, so the frames stacked at a lower part are simultaneously operated by the connection of the first member to third member of the vertical partition member so the operation of the vertical partition member in the entire frame can be described as the operation of the uppermost frame.

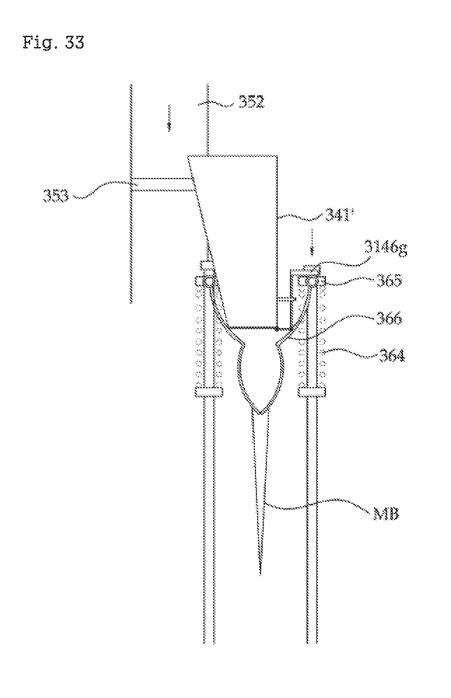

When a generally uniform powdered medicine is distributed in the unit cells by the horizontal expansion of the vertical partition members, as shown in FIG. 29, the spacing of unit cells 314′ in a state where it is expanded to match the spacing of the dispensing means arranged underneath is maintained as the spacing of the unit cells filled with the powdered medicine is adjusted.

That is, the spacing between the first (\textcircled{1}) to third (\textcircled{3}) unit cells filled with powdered medicine distributed between L1 and L2, L2 and L3, L4 and L5 respectively, is maintained as L2 to L6 are generally moved in a horizontal direction, to form a space between L1 and L2, L3 and L4, and L5 and L6 respectively, so that through this spacing, the space in between the storage slots of the dispensing means arranged at a lower part is adjusted to match, and also by maintaining the spacing in between the first (\textcircled{1}) to third (\textcircled{3}), when the frame is moved vertically the powdered medicine is prevented from falling over to a frame of the middle layer from a frame of the uppermost layer while powdered medicine may be dropped to the dispensing means.

Also, as shown in FIG. 29, after expanding the vertical partition member, a frame of the uppermost layer is moved vertically, so that the powdered medicine in the frame is dropped while simultaneously the height of the powdered medicine placed on the middle layer is uniformly weighed using the frame, and the vertical partition member of L1 to L6 is returned as shown in FIG. 28 after dropping the powdered medicine of the uppermost layer and the middle layer, so the vertical partition member is expanded to its maximum at a state where L2 is attached to L1, L4 to L3, and L6 to L5, and then moving the uppermost layer vertically to drop, wherein this method is used to sequentially drop the powdered medicine of each layer to have it stacked on the dispensing means. At this time, through a guide groove 3113a formed at a lower part of the horizontal partition member of the lowermost layer, it is possible to move without being interrupted by a hanging protrusion.

According to another method, when the total volume of the powdered medicine is known, the spacing of the vertical partition members at which the powdered medicine becomes aligned horizontally with the upper end of each unit cell may be calculated by a simple calculation, and the vertical partition member is moved at the same interval and then the powdered medicine is injected, and the upper part of the partition member is evened out. At this time, it is possible to install a scale along the vertical direction to accurately identify the spacing between the vertical partition members.

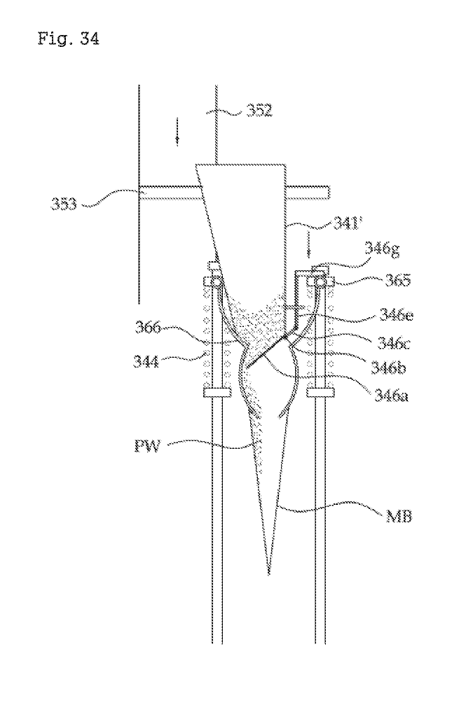

Next, as shown in FIGS. 30 and 31, a powdered medicine which is partitioned by a partition means 310 drops to a dispensing means arranged under the partition means, and a second driving means 330 connected to the uppermost frame 3111 is operated first to allow the powdered medicine to drop into the unit cells 314′ divided by the horizontal partition member 312 and the vertical partition member.

That is, the second driving means 330 moves the frames 3111, 3112, 3113 of the partition means in the vertical direction and the powdered medicine filled in the unit cells is dropped stepwise to the distribution means, wherein the powdered medicine in the frame located at a lower part thereof is weighed to be compared to be equal with the height of the frame, thereby preventing the powdered medicine in the unit cell from being lost in the process of moving the frame to the storage slot side by the guide plate 341a which is extended with an incline to one side of the storage slot 341.

On the other hand, in the operation of the present invention only the process of dropping from the first unit cell of the uppermost frame 3111 will be described as follows. This is because the dropping process of powdered medicine is the same to that of other frames.

When the uppermost frame 3111 is moved in a vertical direction by the operation of the second driving means, a powdered medicine (PW) is dropped inside the storage slot 341 by way of a guide plate 341a of a storage slot 341 located on a lower part.

The dropped powdered medicine is placed in the storage slot 341, and is lowered by operation of the third driving means 350 as shown in FIG. 32.

As shown in FIG. 33, it is located on the upper side of the auxiliary slot unit 360 arranged under the dispensing means 340, and when the storage slot 341 is lowered, the pressing unit 346g of the opening means 346 coupled to the storage slot 341′ presses the guide bar 365 and the pressurized guide bar compresses and lowers the first spring 364 and the lower end of the powdered medicine guider 366 is inserted between the medicine wrapping paper (MB), making the gap in between the medicine wrapping paper to be spaced apart from each other.

In this state, as shown in FIG. 34, the powdered medicine guider 366 cancels out the spring force of the second spring due to the storage slot which is lowered when the compressive force generated by the continuous compression of the first spring 364 is stronger than the spring force of the second spring, and the powdered medicine guider 366 is opened apart oppositely from each other and the medicine wrapping paper becomes more spaced apart while a cover 364a of the lower part of the storage slots 341′ is opened by an operation of a link 346c and a perpendicular shaft of an opening means in a pressed state, so that the powdered medicine (PW) that used to be stored is dropped and stored in a medicine wrapping paper (MB).

A plurality of split sealing machines 370 arranged in evenly spaced manner as shown in FIG. 32 operate oppositely facing the medicine wrapping paper in a direction towards it to seal it to make the medicine wrapping paper separated from each other.

Here, each shaft is connected to a motor (not shown) to operate, and the motor is not shown but is controlled by a control unit for controlling each operation.

This operation is repeatedly performed and the powdered medicine divided by the partition means may be injected in a continuous process.

In this way, it is possible not only to respond to an appropriate amount in compliance with the amount required by a patient, but also to rapidly divide the powdered medicine uniformly, and thereby it is possible to obtain a large effect with less expense in a hospital handling a large amount of powdered medicine.

Although the present invention has been described with reference to the preferred embodiments, it is intended to aid in the understanding of the technical content of the present invention, and the technical scope of the invention is not intended to be limited thereto.

That is, it would be obvious to those skilled in the art that various changes and modifications can be made to the invention without departing from the technical gist of the present invention, and such changes and modifications are within the technical scope of the present invention in view of the interpretation of the claims.

1. A powdered medicine dispensation packaging apparatus characterized in that it comprises:
a partition means having a frame with a space of predetermined size, that divides the frame horizontally and vertically to form unit cells for powdered medicine to be uniformly distributed;
a driving means connected to a vertically partitioning member whereby a vertical spacing of a member is adjusted;
a dispensing means arranged at a lower part of the partition means dispensing divided powdered medicine to split inject into a medicine wrapping paper; and
a holding unit supporting the medicine wrapping paper.

2. A powdered medicine dispensation packaging apparatus characterized in that it is configured to comprise:
a partition means having a frame with a space of predetermined size, that divides the frame horizontally and vertically to form unit cells for powdered medicine to be uniformly distributed;
a driving means connected to a vertically partitioning member whereby a vertical spacing of a member is adjusted;
a dispensing means arranged under the partition means that dispenses divided powdered medicine;
a plurality of individual slots whereby the divided powdered medicine dispensed from a powdered medicine dispensing apparatus is moved individually;
an upper guide plate supporting the individual slots horizontally;
a first horizontal driving unit that moves the individual slots horizontally as it moves horizontally along the upper guide plate;
a first vertical driving unit provided at one side of the first horizontal driving unit, that moves the individual slots vertically;
a second horizontal driving unit located at a lower part of the first horizontal driving unit, that moves the individual slots which were transferred by the first vertical driving unit, horizontally;
an auxiliary slot unit provided under the second horizontal driving unit, which simultaneously opens an upper part of a medicine wrapping paper moving horizontally and injects powdered medicine stored in the individual slots into the medicine wrapping paper;
a lower guide plate arranged between the second horizontal driving unit and auxiliary slot unit to guide movement of individual slots; and
a second vertical driving unit that moves individual slots which moved the lower guide plate, towards the upper guide plate of an upper part.

3. The powdered medicine dispensation packaging apparatus according to claim 1, characterized in that the partition means is provided with a frame, a plurality of horizontal partition members that divide the frame horizontally, a plurality of vertical partition members that are perpendicular to the horizontal partition members and divide the frame vertically, and a sliding plate arranged at a lower part of the frame, which folds as unit cells partitioned by the horizontal partition members and vertical partition members open and close downwardly and slides, and a guide groove is formed at a lower part of the partition means whereby the dispensing means is slidably attached and detached.

4. The powdered medicine dispensation packaging apparatus according to claim 3, characterized in that the dispensing means allows a dispensing slot corresponding with horizontal unit cells to be arranged, and each vertical unit cell to be slidably attached and detached into a respective divided segment.

5. The powdered medicine dispensation packaging apparatus according to claim 3, characterized in that the vertical partition member is configured to have a vertical plate with slots formed to be spaced in correspondence with the horizontal partition member, a perpendicular plate extending perpendicularly at both ends of the vertical plate, an extending plate extending horizontally in a direction opposite to each other at the perpendicular plate, and a flat plate extending orthogonally to the extending plate to be connected with the driving means.

6. The powdered medicine dispensation packaging apparatus according to claim 1, characterized in that the driving means is configured to have a driving rotary shaft arranged horizontally in a vertical direction to the partition means, that is operated by a handle, a driven rotary shaft arranged at a position facing the driving rotary shaft, a plurality of rotating bodies each coupled to the driving rotary shaft and driven rotary shaft, and a moving member connecting to each of the plurality rotating bodies, and the rotating bodies increase in diameter towards an outer direction from the shaft, and the diameter of the rotating bodies are in proportion to a distance moved horizontally by the vertical partition member connected to each rotating body.

7. The powdered medicine dispensation packaging apparatus according to claim 1, characterized in that the powdered medicine dispensing apparatus is configured to further include a horizontal separating plate and a vertical separating plate whereby, out of the unit cells partitioned by the vertical partition members and horizontal partition members, only the unit cells where powdered medicine is injected and partitioned are distinguished and partitioned, and the vertical separating plate differs in length according to the position of the horizontal separating plate which is positioned at the horizontal partition means.

8. The powdered medicine dispensation packaging apparatus according to claim 2, characterized in that the dispensing means is configured to have a plurality of slots partitioned by the partition means, that enables divided powdered medicine to be dispensed towards the individual slot arranged below, a fixing unit fixing the slot on a belt, a roller and shaft for step-moving the slot vertically, a cover arranged at a lower part of the slot to open and close the lower part as it rotates by a hinge, and a hanging bar extended towards a side of the cover, which is pressed by a pressing bar according to a movement of the slot to open the cover.

9. The powdered medicine dispensation packaging apparatus according to claim 2, characterized in that the individual slot is configured to have a slot storing powdered medicine divided and dropped from the dispensing means, a cover blocking a lower part of the slot, an opening means operating the cover to open and close the lower part of the slot, and a side fixing unit enabling the slot to be guided horizontally by the first horizontal driving unit.

10. The powdered medicine dispensation packaging apparatus according to claim 9, characterized in that the opening means is configured to have a hinge rotatably connecting the cover to the slot, a link with a side coupled to the hinge side and a link shaft formed on the other side, a perpendicular bar rotatably connected to the link shaft, a pressing unit installed at an end part of the perpendicular shaft, and a guiding unit guiding the perpendicular bar in a state of being supported on the slot.

11. The powdered medicine dispensation packaging apparatus according to claim 2, characterized in that the first and second horizontal driving units are configured to have a pressing unit pressing the individual slot horizontally, a belt with the pressing unit fixed, and a roller operating the belt.

12. The powdered medicine dispensation packaging apparatus according to claim 2, characterized in that the first and second vertical driving units are configured to have a roller coupled to a shaft, a belt rotating by the roller, and a guiding unit coupled to the outer side of the belt, which seats the horizontally transferred individual slot.

13. The powdered medicine dispensation packaging apparatus according to claim 2, characterized in that the auxiliary slot unit is further provided with a plurality of perpendicular shafts, an upper fixing bar installed at an upper part of the perpendicular shaft, a first spring positioned between a lower fixing bar installed at a position spaced with a predetermined spacing at the upper fixing bar, a guide bar installed at a perpendicular bar so that the guide bar is supported at an upper end of the first spring, and a pair of powdered medicine guiders rotatably installed on the guide bar, expand operating by the individual slot to guide powdered medicine to the medicine wrapping paper, and a second spring which is elastically supported in a direction opposite to each other on the powdered medicine guiders in connection with the guide bar.

14. A powdered medicine dispensing apparatus, characterized in that it comprises a multilayered partition means having a frame with a space of predetermined size, that divides the frame horizontally and vertically to form unit cells for powdered medicine to be uniformly distributed; a first driving means connected to a vertically partitioning member of the multilayered partition means whereby a vertical spacing of a member is adjusted; and a second driving means which moves each of the multilayered partition means individually.

15. A powdered medicine dispensing apparatus according to claim 14, characterized in that the first driving means is arranged at a lower part of the frame and individually connected to a vertical partition member, whereby each is operated individually.

16. A powdered medicine dispensing apparatus according to claim 15, characterized in that a diameter of a rotating body is formed so that each of the first driving means operates proportionally to a distance moved by a vertical partition member.

17. A powdered medicine dispensing apparatus according to claim 16, characterized in that the multilayered partition means is configured to have a frame stacked with a plurality thereof and arranged to be slidable with each other, a plurality of horizontal partition members that divide the frame horizontally, a plurality of vertical partition members that divide in a vertical direction perpendicular to the horizontal partition members, and a bottom plate for controlling a bottom surface of a frame arranged at the lowermost part of the frame.

18. A powdered medicine dispensing apparatus according to claim 17, characterized in that the vertical partition member is configured to have a lower guide groove formed to have an inclined upper part and stepped lower part, and a first to third member formed to have a plurality of guide grooves in which the horizontal partition member is inserted into and slides along a length direction.

19. A powdered medicine dispensing apparatus according to claim 18, characterized in that an upper protrusion is formed closely contacting the lower guide groove at an inclined surface of the second and third members so that the vertical partition member may be guided as it moves in a length direction by closely contacting the lower guide groove.

20. A powdered medicine dispensation packaging apparatus for packaging using a powdered medicine dispensing apparatus according to claim 14, characterized in that it comprises a dispensing means arranged under a partition means to load powdered medicine partitioned into unit cells as it falls, a third driving means for lifting the dispensing means, an auxiliary slot unit provided under the dispensing means to open an upper part of a medicine wrapping paper by a falling force of the vertically moved distribution means and to simultaneously inject powdered medicine stored in the dispensing means into the medicine wrapping paper, and a plurality of split sealing machines for individually separating and packaging medicine wrapping paper in a state in which powdered medicine is injected.
